(19) United States
(12) Patent Application Publication
(10) Pub. No.: US 2022/0399583 A1
(43) Pub. Date: Dec. 15, 2022

(54) BATTERY MODULE FOR SUPPLYING ELECTRICAL MOTOR

(71) Applicant: NEXPOWERENERGY INC., Temple City, CA (US)

(72) Inventors: JACK TALUN CHIOU, LA VERNE, CA (US); DAVID HSIAO-PAI SHEN, Arcadia, CA (US)

(21) Appl. No.: 17/346,193

(22) Filed: Jun. 11, 2021

(51) Int. Cl. H01M 10/44; H01M 50/30; H01M 10/0525

(52) U.S. Cl. CPC H01M 10/441; H01M 50/30; H01M 10/0525; H01M 2220/20

(57) ABSTRACT

A battery module for an electric vehicle includes a case and a plurality of rechargeable battery cells stored inside the case and connected in series, wherein the plurality of rechargeable battery cells is stored in a parallel configuration inside the case in a plurality of rows, and at least one of the plurality of rechargeable battery cells is stored in each of the plurality of rows. The battery module further includes an overcharge protection circuit having a voltage threshold for each of the plurality of rechargeable battery cells to prevent overcharging. Each of the plurality of rechargeable battery cells has a nominal voltage and a maximum voltage. The voltage threshold is larger than the nominal voltage and smaller than the maximum voltage. All of the plurality of rechargeable battery cells are comprised of lithium iron phosphate LiFePO₄, and a number of the plurality of rechargeable battery cells is five.

### FIELD

The present disclosure generally relates to electrochemical batteries. In particular, the present disclosure relates to batteries used in electric vehicles, such as hybrid-electric vehicles or plug-in hybrid vehicles (PHEV) that are collectively referred to as “HEVs”, that derive some or all of their motive power through the battery or battery system.

### BACKGROUND

HEVs make up a significant portion of the automobile market mainly due to the ability to promote fuel economy and reduce vehicle emissions by using a combination of electric power and combustion. Many efforts have been put into increasing the efficiency of automobile (e.g., cars, trucks, etc.) batteries. An ongoing goal for the automobile battery is to retain high energy density, which means high voltage and light weight.

Conventional batteries for an HEV may use nickel metal hydride (Ni-MH) cells. However, Ni-MH battery cells are often heavier than lithium ion (Li-ion) battery cells and have a lower nominal voltage. A battery module in a Toyota® Prius®' has six Ni-MH battery cells and weighs more than 1 kilogram. The voltage of a Toyota® Prius® battery pack is 7.2V. A battery module with five Li-ion battery cells weighs about 1.2 kilograms but has 16V output. That is to say, a battery module with five Li-ion battery cells weighs less than two Toyota® Prius battery packs and has a higher voltage. Therefore, Li-ion battery cells have a high energy density.

While Ni-MH battery cells do not require a balancing circuit due to their characteristics, such a balancing circuit is needed for Li-ion battery cells within a Li-ion battery module to ensure even charging across the battery cells.

The temperature of the battery cells, especially during charging and discharging, affects their performance. Therefore, there remains a need to provide compact cooling structure for a Li-ion battery pack.

Therefore, there is room for improvement within the art.

### SUMMARY OF THE INVENTION

In accordance with a first aspect of the present disclosure, a battery module for an electric motor vehicle includes a case, a plurality of rechargeable battery cells, and an overcharge protection circuit. The plurality of rechargeable battery cells is stored inside the case and connected in series. Each of the plurality of battery cells has a nominal voltage and a maximum voltage. The overcharge protection circuit has a voltage threshold for each of the plurality of rechargeable battery cells to prevent overcharging. The voltage threshold is larger than the nominal voltage and smaller than the maximum voltage.

In an embodiment of the first aspect, each of the plurality of rechargeable battery cells is lithium-based and selected from the group consisting of lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), or lithium nickel cobalt aluminum oxide LiNiCoAlO₂.

In another embodiment of the first aspect, the case further includes at least one air vent. A number of the plurality of rechargeable battery cells may be five.

In yet another embodiment of the first aspect, the nominal voltage may be the same for each of the plurality of rechargeable battery cells. The overcharge protection circuit prevents overcharging through dissipation via resistors.

In accordance with a second aspect of the present disclosure, a battery module for an electric motor vehicle includes a rectangular case and a plurality of rechargeable battery cells. The plurality of rechargeable battery cells is stored inside the case and connected in series. The case includes at least one air vent on at least one side of the case.

In an embodiment of the second aspect, each of the plurality of rechargeable battery cells is lithium-based and selected from the group consisting of lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), or lithium nickel cobalt aluminum oxide LiNiCoAlO₂.

In another embodiment of the second aspect, all of the plurality of rechargeable battery cells are comprised of lithium titanate Li₄Ti₅O₁₂, and a number of the plurality of rechargeable battery cells is seven.

In yet another embodiment of the second aspect, all of the plurality of rechargeable battery cells are comprised of lithium iron phosphate LiFePO₄, and a number of the plurality of rechargeable battery cells is five.

In another embodiment of the second aspect, a number of the plurality of rechargeable battery cells is four, and each of the plurality of rechargeable battery cells is selected from a group consisting of lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), and lithium nickel cobalt aluminum oxide LiNiCoAlO₂.

In yet another embodiment of the second aspect, the battery module includes an overcharge protection circuit that has a voltage threshold for each of the plurality of rechargeable battery cells to prevent overcharging. Each of the plurality of rechargeable battery cells has a nominal voltage and a maximum voltage. The voltage threshold is larger than the nominal voltage and smaller than the maximum voltage. The overcharge protection circuit prevents overcharging through dissipation via resistors.

In accordance with a third aspect of the present disclosure, a battery module for an electric motor vehicle includes a case and a plurality of rechargeable battery cells. The plurality of rechargeable battery cells is stored inside the case and connected in series. The plurality of rechargeable battery cells is stored in a parallel configuration inside the case in a plurality of rows. At least one of the plurality of rechargeable battery cells is stored in each of the plurality of rows.

In an embodiment of the third aspect, each of the plurality of rechargeable battery cells is lithium-based and selected from the group consisting of lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), or lithium nickel cobalt aluminum oxide LiNiCoAlO₂.

In an embodiment of the third aspect, the battery module further includes an overcharge protection circuit that has a voltage threshold for each of the plurality of rechargeable battery cells to prevent overcharging. Each of the plurality of rechargeable battery cells has a nominal voltage and a maximum voltage. The voltage threshold is larger than the nominal voltage and smaller than the maximum voltage.

In another embodiment of the third aspect, the case further includes at least one air vent.

In yet another embodiment of the third aspect, the plurality of rows includes a first row storing three of the plurality of rechargeable battery cells and a second row storing two of the plurality of rechargeable battery cells. A free battery cell space in the second row stores an overcharge protection circuit.

### BRIEF DESCRIPTION OF THE DRAWINGS

Embodiments of the present disclosure will now be described, by way of example only, with reference to the attached figures.

FIG. 1 is a schematic drawing of a related art Ni-MH HEV battery installed in an HEV.

FIG. 2 is a schematic drawing of a related art Ni-MH battery cell.

FIG. 3 is a schematic drawing illustrating an example LiFePO₄ cell structure in accordance with an example embodiment of the present disclosure.

FIG. 4 is a schematic drawing illustrating an example battery module case in accordance with an example embodiment of the present disclosure.

FIG. 5 is a schematic drawing illustrating an example voltage balancing module in accordance with an example embodiment of the present disclosure.

FIG. 6 is a schematic drawing illustrating an example LiFePO₄ battery module with a voltage balancing module in accordance with an example embodiment of the present disclosure.

FIG. 7 is a schematic drawing illustrating an example LiFePO₄ lithium battery module with a balancer in accordance with an example embodiment of the present disclosure.

FIG. 8 illustrate fourteen example LiFePO₄ battery modules as replacement for the twenty-eight Ni-MH-based battery modules.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “comprising” when utilized, means “including, but not necessarily limited to”; it specifically indicates open-ended inclusion or membership in the so-described combination, group, series, and the equivalent.

An HEV has an internal combustion engine (e.g., operates on fuel such as gasoline, etc.) and an electric motor which are separated from one another. The HEV may utilize electric power stored in a Ni-MH battery instead of power from combustion whenever possible. The HEV may operate through the electric motor when driven at low speeds, may require energy from the internal combustion engine upon acceleration, and may use both the electric motor and the internal combustion engine to sufficiently power the vehicle during light acceleration.

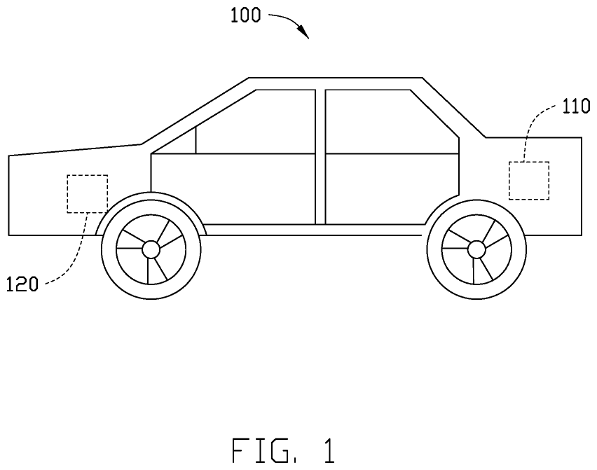

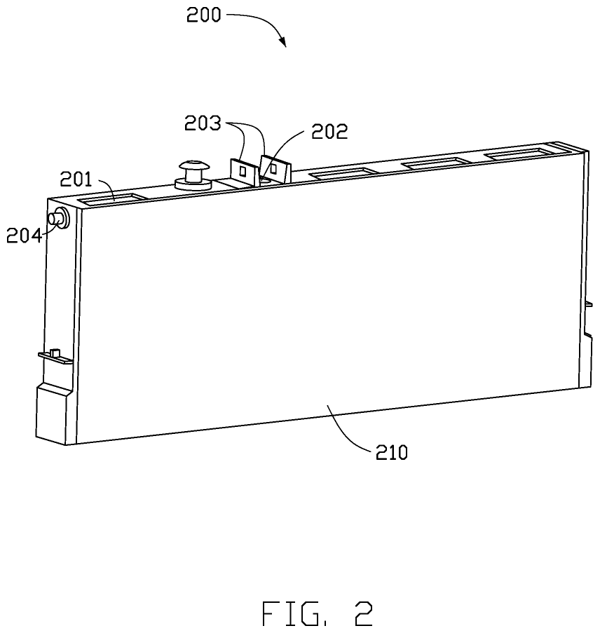

FIG. 1 is a schematic drawing of a related art Ni-MH HEV battery installed in an HEV. FIG. 2 is a schematic drawing of a related art Ni-MH battery cell.

In FIG. 1, the HEV 100 has an internal combustion engine 120. The Ni-MH battery pack 110 is connected to an electric motor (not explicitly shown). The Ni-MH battery pack 110 provides DC power, which is transmitted to an electric motor that drives the wheels of the HEV 100 when the vehicle is driven at low speeds.

The battery pack of an HEV may include a number of Ni-MH battery modules. For example, a Toyota® Prius® battery pack may include 28 Ni-MH battery modules. Each of these battery modules 200 (illustrated in FIG. 2) may hold a charge of 7.2 volts.

In FIG. 2, the battery module 200 may contain, for example, six Ni-MH battery cells in series and enclosed in a plastic case 210. A one-way vent 201 is provided on an upper surface of the case 210 for pressure relief. The upper surface of the case may also include a receptacle for holding a temperature sensor 202. The receptacle may be two clips 203 provided to hold the temperature sensor 202 in place. An electrode terminal 204 is provided on a side surface of the case 210 to be electrically connected to other battery modules.

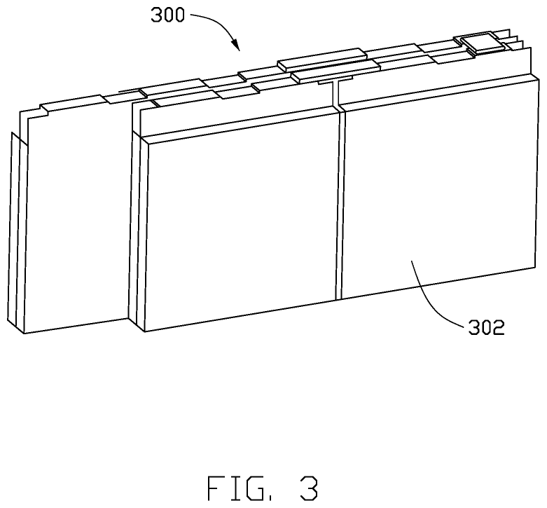

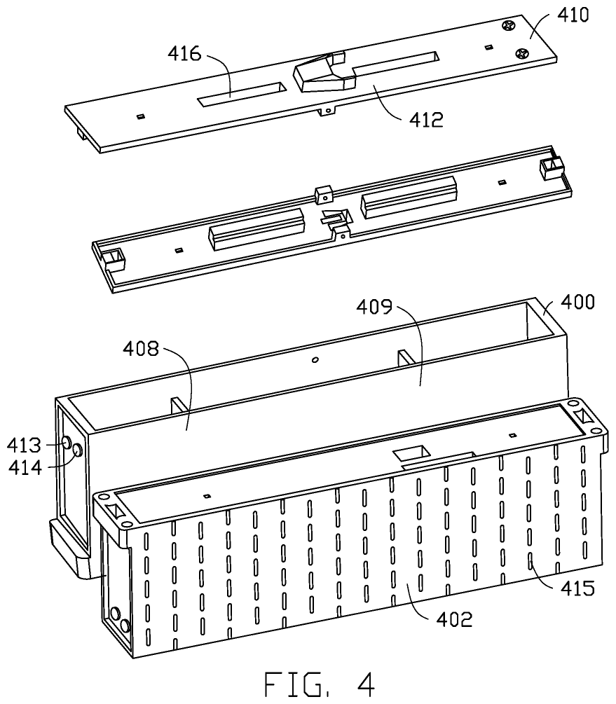

FIG. 3 is a schematic drawing illustrating an example LiFePO₄ cell structure in accordance with an example embodiment of the present disclosure. FIG. 4 is a schematic drawing illustrating an example battery module case in accordance with an example embodiment of the present disclosure.

FIG. 3 illustrates an example LiFePO₄ battery cell structure 300 in a 5-series (5S) configuration. The example LiFePO₄ battery cell structure 300 may include a plurality of battery cells 302, for example five LiFePO₄ battery cells (e.g., lithium battery cells). FIG. 4 illustrates a battery case 400. In FIG. 4 the battery case 400 may include a front side 402, a rear side 406, a first lateral side 408, a second lateral side 409 opposite and parallel to the first lateral side 408, a top side 410, and an underside 411. The top side 410 of the case 400 may include a holder 412 for storing a temperature sensor (not shown). The case 400 may also include a cathode terminal 413 and an anode terminal 414.

On the front side 402 and rear side 406 of the battery case 400, there are a plurality of ridges 415 to allow space between two adjacent battery modules. The space between two adjacent battery modules enables efficient cooling of the two adjacent battery modules. The plurality of ridges 415 may further allow interlocking of two adjacent battery modules. The ridges 415 may also prevent accidentally mixing the lithium battery cells with preexisting Ni-MH battery cells in a battery pack.

In one example embodiment, the battery case 400 may further include a plurality of perforations 416 on each of the top side 410 and the underside 411. The plurality of perforations 416 allow for the heat exchange of the plurality of battery cells 302 through enhanced air flow.

In yet another embodiment, the battery case 400 may further include dividers (not shown) such that the lithium battery cells (e.g., battery cells 302 in FIG. 3) can be stored inside smaller compartments to prevent movement of the battery cells while the vehicles are in motion.

As depicted in FIG. 3, in one embodiment of the disclosure, the battery cell structure 300 may include five lithium battery cells 302 that are electrically connected in series and are rechargeable. In the embodiment illustrated in FIG. 3, two battery cells 302 may be layered in a first row and three battery cells 302 may be layered in a second row parallel to the first row. The plurality of battery cells 302 may be stored inside the case 400 or in a layered configuration in the case 400 to interlock the battery cells to an existing hardware.

The lithium battery cells (e.g., 302 in FIG. 3) may include lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (or NMC), lithium nickel cobalt oxide LiNiCoO₂ (or NC), or lithium nickel cobalt aluminum oxide LiNiCoAlO₂.

In one embodiment of the present disclosure, the battery cells may include Li₄Ti₅O₁₂ cells, and the number of battery cells within an example LiFePO₄ battery cell structure 300 may be seven. For example, three Li₄Ti₅O₁₂ battery cells may be layered in a first row, and four Li₄Ti₅O₁₂battery cells may be layered on a second row parallel to the first row.

In one embodiment of the present disclosure, the battery cells may include LiFePO₄ cells, and the number of battery cells within an example LiFePO₄ battery cell structure 300 may be five. For example, three LiFePO₄ battery cells may be layered in a first row, and two LiFePO₄ battery cells may be layered in a second row parallel to the first row.

In another embodiment of the present disclosure, the battery cells may include LiCoO₂ cells, and the number of battery cells within an example LiFePO₄ battery cell structure 300 may be four. For example, two LiCoO₂ battery cells may be layered in a first row, and two LiCoO₂ battery cells may be layered in a second row parallel to the first row.

In one embodiment of the present disclosure, the battery cells may include LiMn₂O₄ cells, and the number of battery cells within an example LiFePO₄ battery cell structure 300 may be four. For example, two LiMn₂O₄ battery cells may be layered in a first row, and two LiMn₂O₄ battery cells may be layered in a second row parallel to the first row.

In another embodiment of the present disclosure, the battery cells may include LiNiMnCoO₂ cells, and the number of battery cells within an example LiFePO₄ battery cell structure 300 may be four. For example, two LiNiMnCoO₂ battery cells may be layered in a first row, and two LiNiMnCoO₂ battery cells may be layered in a second row parallel to the first row.

In one embodiment of the present disclosure, the battery cells may include LiNiCoO₂ cells, and the number of battery cells within an example LiFePO₄ battery cell structure 300 may be four. For example, two LiNiCoO₂ battery cells may be layered in a first row, and two LiNiCoO₂ battery cells may be layered in a second row parallel to the first row.

In another embodiment of the present disclosure, the battery cells may include LiNiCoAlO₂ cells, and a number of battery cells within an example LiFePO₄ battery cell structure 300 may be four. For example, two LiNiCoAlO₂ battery cells may be layered in a first row, and two LiNiCoAlO₂ battery cells may be layered in a second row parallel to the first row.

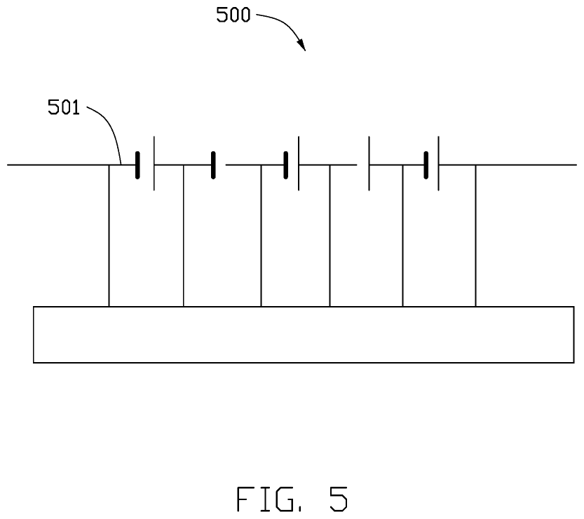

FIG. 5 is a schematic drawing illustrating an example voltage balancing module 500 in accordance with an example embodiment of the present disclosure. The voltage balancing module 500 includes five balancing circuits 501. Each balancing circuit monitors and regulates a voltage of each of the plurality of rechargeable battery cells (e.g., 302 in FIG. 3). The five balancing circuits 501 are connected in series. The voltage balancing module 500 may include a balancing circuit board 600.

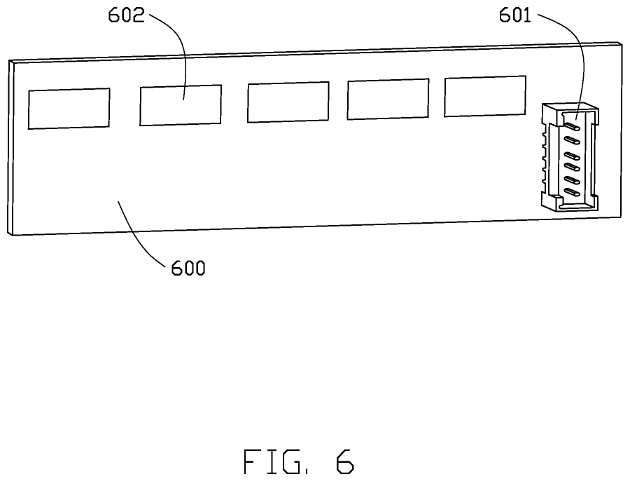

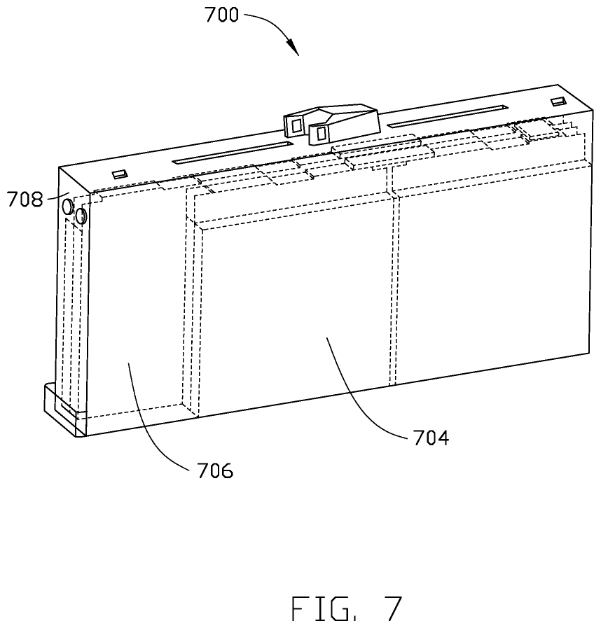

FIG. 6 is a schematic drawing illustrating the balancing circuit board 600. For example, five electric contacts 601 are provided at one corner of the balancing circuit board 600. Each electric contact 601 connects to a battery cell in the battery module (e.g., 700 in FIG. 7). The balancing circuit board 600 may also include, for example, five groups of resistors 602. In one embodiment, three resistors 602 may be included in each group. The balancing circuit board 600 may further include additional circuit elements (not shown) to monitor voltage of each individual lithium battery cell within the battery module. For example, when the circuit element detects voltage of a cell that exceeds a pre-set voltage, the circuit element would connect the battery to the corresponding resistor group, and may discharge any excess voltage through the resistors 602. The voltage balancing module 500 may prevent the battery cells within the module from being overcharged at any time, especially during vehicle braking that may cause a rush in charging current.

FIG. 7 is a schematic drawing illustrating an example LiFePO₄ battery module with a balancer in accordance with an example embodiment of the present disclosure.

FIG. 7 illustrates a 5-Series (5S) LiFePO₄ battery module 700. In one embodiment of the present disclosure, the LiFePO₄ battery module 700 may include five battery cells 704 with two rows in a battery module casing 708, where there are three battery cell spots in each row. The voltage balancing module 510 may be arranged inside an empty compartment 706 within the battery module casing 708. The voltage balancing module 510 may be electrically connected to each of the plurality of battery cells 704.

Each of the plurality of battery cells 704 may have a nominal voltage. The plurality of battery cells 704 may have a combined nominal voltage. In one embodiment, the nominal voltage for a LiFePO₄ battery cell may be 3.2V. The battery module 700 with five LiFePO₄ battery cells 704 may have a combined nominal voltage of 16 V. The nominal voltage of a battery module in the related art (e.g., Ni-MH-based battery module 200 in FIG. 2) having six Ni-MH battery cells is approximately 7.2V, and two Ni-MH-based battery modules may have a combined nominal voltage of 14.4V. That is to say, a battery module with five LiFePO₄ battery cells may replace two battery modules with six Ni-MH battery cells in each battery module. In a HEV applying the battery module in the related art, there are twenty-eight Ni-MH-based battery modules, which may equal to a total combined nominal voltage of 201.6 V. As such, fourteen example LiFePO₄ battery modules of the present disclosure, having a total combined nominal voltage of 224 V, may replace twenty-eight Ni-MH-based battery modules.

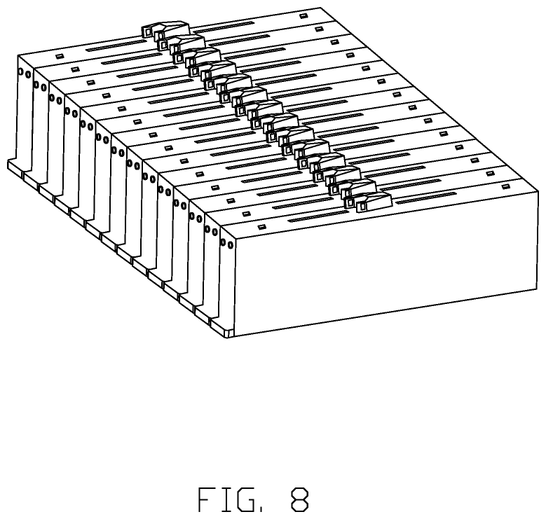

FIG. 8 illustrate fourteen example LiFePO₄ battery modules (e.g., 700 in FIG. 7) as replacement for the twenty-eight Ni-MH-based battery modules to supply power for an entire Toyota Prius. As illustrated in FIG. 8, the LiFePO₄ battery modules are electrically connected in series. When two Ni-MH-based battery modules in the related art (e.g., Ni-MH-based battery module 200 in FIG. 2) weigh about 2.07 kg, a LiFePO₄ battery module (e.g., 700 in FIG. 7) weighs about 1.23 kg. That is to say, replacing a stack of twenty-eight Ni-MH based battery modules with a stack of fourteen example LiFePO₄ battery modules (e.g., 700 in FIG. 7) reduces the weight from 28.98 kg to 17.22 kg.

To preserve the longevity of the lithium battery cells of the present disclosure, a voltage threshold is set by the voltage balancing module (e.g., 510) that is lower than the maximum charging voltage for each lithium battery cell. To promote energy efficiency of the lithium battery cells of the present disclosure, it is preferred that the voltage threshold set by the voltage balancing module (e.g., 510) is higher than the nominal voltage of each lithium battery cell. When the voltage balancing module detects that the voltage threshold is reached for any individual battery cell, the excessive energy of the battery cell is dissipated. The prevention of overcharging or charging to saturation of each individual battery cells may maintain an overall balanced state.

In one embodiment, the nominal voltage may be set slightly higher than the designed nominal voltage such that a processor in an HEV may determine a presence of excessive battery power, which may promote electrical power usage over combustion power usage, thus contributing to an increase in fuel economy while providing faster acceleration.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A battery module for an electric vehicle, the battery module comprising:
a case;
a plurality of rechargeable battery cells stored inside the case and connected in series, wherein each of the plurality of rechargeable battery cells has a nominal voltage and a maximum voltage;
an overcharge protection circuit having a voltage threshold for each of the plurality of rechargeable battery cells to prevent overcharging wherein the voltage threshold is larger than the nominal voltage and smaller than the maximum voltage.

2. The battery module of claim 1, wherein each of the plurality of rechargeable battery cells is lithium-based and selected from a group consisting of lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), and lithium nickel cobalt aluminum oxide LiNiCoAlO₂.

3. The battery module of claim 1, wherein the case comprises at least one air vent.

4. The battery module of claim 1, wherein the nominal voltage is the same for each of the plurality of rechargeable battery cells.

5. The battery module of claim 1, wherein the overcharge protection circuit prevents overcharging through dissipation via resistors.

6. The battery module of claim 1, wherein a number of the plurality of rechargeable battery cells is five.

7. A battery module for an electric vehicle, the battery module comprising:
a rectangular case;
a plurality of rechargeable battery cells stored inside the case and connected in series, wherein the case comprises at least one air vent on at least one side of the case.

8. The battery module of claim 7, wherein each of the plurality of rechargeable battery cells is lithium-based and selected from a group consisting of lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), and lithium nickel cobalt aluminum oxide LiNiCoAlO₂.

9. The battery module of claim 8, wherein all of the plurality of rechargeable battery cells are comprised of lithium titanate Li₄Ti₅O₁₂, and a number of the plurality of rechargeable battery cells is seven.

10. The battery module of claim 8, wherein all of the plurality of rechargeable battery cells are comprised of lithium iron phosphate LiFePO₄, and a number of the plurality of rechargeable battery cells is five.

11. The battery module of claim 8, wherein a number of the plurality of rechargeable battery cells is four, and each of the plurality of rechargeable battery cells is selected from a group consisting of lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), and lithium nickel cobalt aluminum oxide LiNiCoAlO₂.

12. The battery module of claim 7, further comprising an overcharge protection circuit having a voltage threshold for each of the plurality of rechargeable battery cells to prevent overcharging, wherein:
each of the plurality of rechargeable battery cells has a nominal voltage and a maximum voltage; and
the voltage threshold is larger than the nominal voltage and smaller than the maximum voltage.

13. The battery module of claim 12, wherein the overcharge protection circuit prevents overcharging through dissipation via resistors.

14. A battery module for an electric vehicle, the battery module comprising:
a case; and
a plurality of rechargeable battery cells stored inside the case and connected in series, wherein:
the plurality of rechargeable battery cells is stored in a parallel configuration inside the case in a plurality of rows; and
at least one of the plurality of rechargeable battery cells is stored in each of the plurality of rows.

15. The battery module of claim 14, wherein each of the plurality of rechargeable battery cells is lithium-based and selected from a group consisting of lithium titanate Li₄Ti₅O₁₂, lithium iron phosphate LiFePO₄, lithium cobalt oxide LiCoO₂, lithium manganese oxide LiMn₂O₄, lithium nickel manganese cobalt oxide LiNiMnCoO₂ (NMC), lithium nickel cobalt oxide LiNiCoO₂ (NC), and lithium nickel cobalt aluminum oxide LiNiCoAlO₂.

16. The battery module of claim 14, further comprising an overcharge protection circuit having a voltage threshold for each of the plurality of rechargeable battery cells to prevent overcharging, wherein:
each of the plurality of rechargeable battery cells has a nominal voltage and a maximum voltage; and
the voltage threshold is larger than the nominal voltage and smaller than the maximum voltage.

17. The battery module of claim 14, wherein the case further comprises at least one air vent.

18. The battery module of claim 14, wherein:
the plurality of rows comprises a first row storing three of the plurality of rechargeable battery cells and a second row storing two of the plurality of rechargeable battery cells; and
a free battery cell space in the second row stores an overcharge protection circuit.
